(19) United States
(12) Patent Application Publication
(10) Pub. No.: US 2014/0160354 A1
(43) Pub. Date: Jun. 12, 2014

(54) DISPLAY APPARATUS AND DISPLAY METHOD

(71) Applicant: Samsung Electronics Co., Ltd., Suwon-si (KR)

(72) Inventors: Jae-sung PARK, Seoul (KR); Myoung-Jong SONG, Hwaseong-si (KR); Bong-hwan CHO, Suwon-si (KR)

(73) Assignee: Samsung Electronics Co., Ltd., Suwon-si (KR)

(21) Appl. No.: 14/098,827

(22) Filed: Dec. 6, 2013

(30) Foreign Application Priority Data
Dec. 6, 2012 (KR) 10-2012-0141237

(51) Int. Cl. H04N 5/268

(52) U.S. Cl. CPC H04N 5/268
USPC 348/564

(57) ABSTRACT

A display apparatus and a display method are provided. The display apparatus includes a plurality of receivers which are configured to receive a plurality of contents of a multi-view content, a plurality of signal processors which are configured to independently convert frame rates of the plurality of contents, and an output part which is configured to alternately output the plurality of contents according to the converted frame rates.

### CROSS-REFERENCE TO RELATED APPLICATION

This application claims priority from Korean Patent Application No. 10-2012-141237, filed on Dec. 6, 2012, in the Korean Intellectual Property Office, the disclosure of which is incorporated herein by reference in its entirety.

### BACKGROUND

1. Field

Methods and apparatuses consistent with exemplary embodiments relate to a display apparatus and a display method, and more particularly, to a display apparatus and a display method which provide a multi-view content display environment in which a plurality of viewers respectively simultaneously view a plurality of contents.

2. Description of the Related Art

The development of digital technology has resulted in the development and supply of various types of electronic products. In particular, various types of display apparatuses, such as a television (TV), a portable phone, a personal computer (PC), a notebook PC, a personal digital assistant (PDA), etc., have been used in most homes.

Needs of users for more various functions have increased with increases the use of display apparatuses. Therefore, electronic product manufacturers have increasingly made efforts to meet the needs of the users, and thus products having new functions have been developed.

A multi-view display technology allows several users to simultaneously view their desired contents through one display apparatus. If a content providing source, such as a broadcasting station, compresses a multi-view content into one piece of image data and transmits the one piece of image data, a display apparatus increases frame rates of the received image data at a time to alternately display decompressed image data. However, if the display apparatus receives different types of contents from various content providing sources and multi-displays the different types of contents, frame rates of the different types of contents may be different from one another. In this case, the frame rates may be converted by using frame rate control (FRC). However, in this process, a resolution is lowered, and intervals of image frames of at least one of a plurality of contents are not uniform. Therefore, an unnatural image is displayed.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a display apparatus and a display method which independently convert frame rates of a plurality of contents by using a plurality of frame rate converters (FRCs) to enable a natural multi-view display without a loss of resolution.

According to an aspect of an exemplary embodiment, there is provided a display apparatus including: a plurality of receivers which are configured to receive a plurality of contents of a multi-view content; a plurality of signal processors which are configured to independently convert frame rates of the plurality of received contents; and an output part which is configured to alternately output the plurality of contents according to the converted frame rates.

The display apparatus may further include a switching part which is configured to connect at least two of the plurality of receivers to the plurality of signal processors.

At least one of the plurality of receivers may include a High Definition Multimedia Interface (HDMI) port.

The display apparatus may further include a preprocessor which is configured to compress image frames of each of the plurality of contents into one image frame and to provide the one image frame to the plurality of signal processors.

If the frame rates of the plurality of contents are different from one another, the preprocessor may insert at least one image frame between image frames of a content having a frame rate that is lower than a frame rate of another content to equally adjust the frame rates of the plurality of contents.

If the frame rates of the plurality of contents are different from one another, the preprocessor may delete at least one of image frames of a content having a frame rate that is higher than a frame rate of another content to equally adjust the frame rates of the plurality of contents.

The display apparatus may further include a preprocessor to format image frames of each of the plurality of contents according to a frame packing method and to provide the formatted image frames to the plurality of signal processors.

The plurality of signal processors may convert the frame rates of the plurality of received contents so that the frame rates are equal to one another.

According to an aspect of another exemplary embodiment, there is provided a display method including: independently receiving a plurality of contents of a multi-view content; independently converting frame rates of the plurality of contents; and alternately outputting the plurality of contents according to the converted frame rates.

The display method may further include: switching at least two of the plurality of received contents to input the at least two of the plurality of received contents to a display apparatus.

At least one of the plurality of contents may be received by using an HDMI port.

The display method may further include: compressing image frames of each of the plurality of received contents into one image frame and providing the one image frame to a plurality of signal processors.

When the frame rates of the plurality of received contents are different from one another, at least one image frame may be inserted between image frames of a content having a frame rate that is lower than a frame rate of another content to equally adjust the frame rates of the plurality of contents.

When the frame rates of the plurality of contents are different from one another, at least one of image frames of a content having a frame rate that is higher than a frame rate of another content may be deleted to equally adjust the frame rates of the plurality of contents.

The display method may further include: formatting image frames of each of the plurality of received contents according to a frame packing method.

The frame rates of the plurality of contents may be independently converted so that the frame rates of the plurality of received contents are equal to one another.

According to an aspect of another exemplary embodiment, there is provided a non-transitory computer-readable recording medium recording a program to perform the display method.

According to an aspect of another exemplary embodiment, there is provided a content providing system including a first eyeglass apparatus, a second eyeglass apparatus, and a display apparatus. The display apparatus includes a plurality of receivers which are configured to receive a plurality of contents of a multi-view content, a plurality of signal processors which are configured to independently convert frame rates of the plurality of received contents, and an output part which is configured to alternately output the plurality of contents according to the converted frame rates. A first content displayed on the first eyeglass apparatus is different from a second content displayed on the second eyeglass apparatus.

The display apparatus of the content providing system may include a switching part which is configured to connect at least two of the plurality of receivers to the plurality of signal processors, and the plurality of signal processors convert the frame rates of the plurality of received contents so that the frame rates are equal to one another.

The first eyeglass apparatus synchronizes with a first sync signal and the second eyeglass apparatus synchronizes with a second sync signal. The first sync signal and the second sync signal respectively correspond to a first user command and a second user command.

### BRIEF DESCRIPTION OF THE DRAWINGS

The above and/or other aspects will be more apparent by describing in detail certain exemplary embodiments with reference to the accompanying drawings, in which:

FIG. 1 is a view illustrating a configuration of a content providing system according to an exemplary embodiment;

FIG. 2 is a block diagram illustrating a configuration of a display apparatus according to an exemplary embodiment;

FIG. 3 is a block diagram illustrating a configuration of a display apparatus further including a switch according to another exemplary embodiment;

FIG. 4 is a block diagram illustrating a configuration of the switch shown in FIG. 3 according to an exemplary embodiment;

FIG. 5 is a block diagram illustrating a configuration of the switch shown in FIG. 3 according to another exemplary embodiment;

FIG. 6 is a block diagram illustrating a configuration of a signal processor according to an exemplary embodiment;

FIGS. 7A through 7C are views illustrating an image formatting method according to a configuration shown in FIG. 6;

FIGS. 8A and 8B are views of a preprocessor according to an exemplary embodiment;

FIG. 9 is a block diagram illustrating a configuration of a display apparatus according to another exemplary embodiment;

FIG. 10 is a view illustrating a communication casting method of transmitting a sync signal according to an exemplary embodiment;

FIG. 11 is a block diagram illustrating a circuit configuration of an output part;

FIG. 12 is a block diagram illustrating a circuit configuration of a display panel;

FIG. 13 is a perspective view illustrating an external appearance of an eyeglass apparatus according to an exemplary embodiment;

FIG. 14 is a block diagram illustrating a configuration of the eyeglass apparatus shown in FIG. 13; and

FIGS. 15 and 16 are flowcharts illustrating display methods according to exemplary embodiments.

### DETAILED DESCRIPTION OF THE EXEMPLARY EMBODIMENTS

Certain exemplary embodiments are described in more detail with reference to the accompanying drawings, in which exemplary embodiments are shown.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

A configuration of a content providing system 100 will now be described.

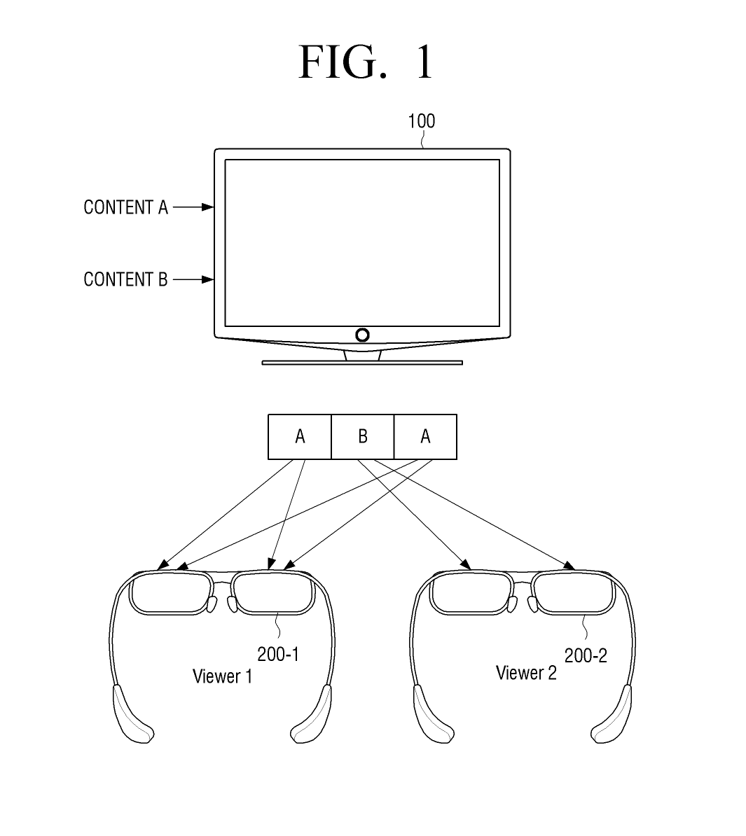

FIG. 1 is a view illustrating a configuration of the content providing system 100 according to an exemplary embodiment. Referring to FIG. 1, the content providing system 100 includes a display apparatus 100 and first and second eyeglass apparatuses 200-1 and 200-2.

The display apparatus 100 displays a 2-dimensional (2D) or a 3-dimensional (3D) content according to a display mode. The display apparatus 100 operates in one of a single 2D mode, a multi-2D mode, a 3D mode, and a multi-3D mode. The single 2D mode is a mode to display an image frame of one 2D content on a display, and the multi-2D mode is a mode to combine image frames of a plurality of 2D contents in order to display a multi-view frame on the display. The 3D mode is a mode to alternately display left and right eye image frames of a 2D content on the display. The multi-3D mode is a mode to combine left and right eye image frames of a plurality of 3D contents to display a 3D multi-view frame on the display.

The term 3D content refers to a content through which a user experiences a stereoscopic effect by using a multi-view image obtained by expressing the same object in different views. The 2D content refers to a content including an image frame expressed in one view. The 3D content includes depth information indicating a degree of the stereoscopic effect.

A content may be a pre-produced content such as a Video On Demand (VoD) content, a premium VoD content, a broadcast content, an Internet content, a local file, an external content connected through a Digital Living Network Alliance (DLNA) network, etc. However, the exemplary embodiment is not limited to these contents. Instead, the content may also include a recorded broadcast content, a real-time broadcast content, or the like.

In the 2D mode, the display apparatus 100 sequentially outputs image frames of one 2D content to display the image frames on a display. The sequentially outputting indicates that image frames of a content are sequentially displayed at predetermined time intervals on the display. Although not shown in FIG. 1, if image frames of a 2D content are A, B, C, D, . . . . , and Z, the image frames A, B, C, D, . . . , and Z are displayed at predetermined time intervals.

In the multi-2D mode, the display apparatus 100 combines image frames of a plurality of 2D contents to alternately display multi-view frames on the display. The alternately displaying allows image frames of one content to be first displayed, and image frames of another content to be alternately displayed to display image frames of different contents. For example, if image frames of one content are A, B, C, D, . . . , and Z, and image frames of another content are a, b, c, . . . , and z, the image frames are displayed in the order of A, a, B, b, C, c, . . . , Z, and z.

In the 3D mode, the display apparatus 100 alternately outputs left and right eye image frames of a 3D content to display the left and right eye image frames on the display. The display apparatus 100 first displays the left image frames of the 3D content and then the right eye image frames of the 3D content according to the same method as discussed above with respect to the multi-2D mode. In an exemplary embodiment, if image frames of a content A, B, C, D, . . . , and Z, include left eye image frames A′, B′, C′, D′, . . . , and Z′, and right eye image frames A″, B″, C″, D″, . . . , and Z″, the image frames are displayed in the order of A′, A″, B′, B″, C′, C″, D′, D″ . . . Z′, and Z″.

According to various exemplary embodiments, the display apparatus 100 may include, but is not limited to, various types of display apparatuses, such as a TV, a portable phone, a personal digital assistant (PDA), a notebook personal computer (PC), a monitor, a tablet PC, an e-book, an e-frame, a kiosk PC, a flexible display, a head mounted display (HDM), etc.

The following exemplary embodiment describes a multi-2D mode. However, the exemplary embodiment is not limited to the multi-2D mode. Instead, other exemplary embodiments include other display modes described above.

FIG. 1 illustrates an exemplary embodiment of a multi-2D mode to alternately display a plurality of 2D contents.

Referring to FIG. 1, the display apparatus 100 alternately displays a plurality of 2D contents (contents A and B), generates a sync signal for synchronizing the first and second eyeglass apparatuses 200-1 and 200-2, respectively, with the contents A and B, and transmits the sync signal to the first and second eyeglass apparatuses 200-1 and 200-2.

The first eyeglass apparatus 200-1 opens left and right shutter glasses when the content A is displayed and closes the left and right shutter glasses when the content B is displayed in accordance with the sync signal. As a result, a first viewer wearing the first eyeglass apparatus 200-1 views only content A of the plurality of alternately displayed contents A and B which is synchronized with the first eyeglass apparatus 200-1. A second viewer wearing the second eyeglass apparatus 200-2 views only the content B which is synchronized with the second eyeglass apparatus 200-2. Alternately displaying the image frames of the different 2D contents is performed at a very fast speed, and an after image effect of retinas lasts when lenses are closed. Therefore, the image frames are displayed as a natural image to a user.

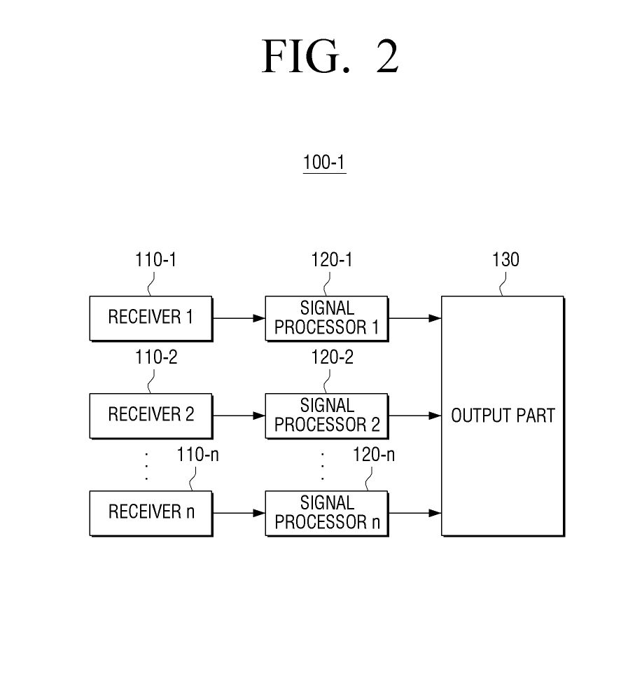

FIG. 2 is a block diagram illustrating a configuration of a display apparatus 100 according to an exemplary embodiment.

Referring to FIG. 2, the display apparatus 100 includes a plurality of receivers 110-1, 110-2, . . . , and 110-n, a plurality of signal processors 120-1, 120-2, . . . , and 120-n, and an output part 130.

The plurality of receivers 110-1, 110-2, . . . , and 110-n respectively receive different contents. The receivers 110-1, 110-2, . . . , and 110-n receive contents from a broadcasting station which transmits broadcast program contents by using a broadcast network or a web server which transmits content files by using the Internet. The receivers 110-1, 110-2, . . . , and 110-n may receive contents from various types of recording media players installed in or connected to the display apparatus 100. A recording media player is an apparatus which plays contents stored on various types of recording media, such as a CD, a DVD, a hard disk, a Blue-ray disk, a memory card, a universal serial bus (USB) memory, etc.

If the plurality of receivers 110-1, 110-2, . . . , and 110-n receive the contents from the broadcasting station, the plurality of receivers 110-1, 110-2, . . . , and 110-n may include elements such as tuners (not shown), demodulators (not shown), equalizers (not shown), etc. If the plurality of receivers 110-1, 110-2, . . . , and 110-n receive the contents from a source such as the web server, the plurality of receivers 110-1, 110-2, . . . , and 110-n may include network interface cards. If the plurality of receivers 110-1, 110-2, . . . , and 110-n receive the contents from the various types of recording media players, the plurality of receivers 110-1, 110-2, . . . , and 110-n may include interfaces (not shown) connected to the recording media players. In an exemplary embodiment, the plurality of receivers 110-1, 110-2, . . . , and 110-n may include, but is not limited to audio & video (AV) terminals, Coordinated Multi-Point (COMP) terminals, High Definition Multimedia Interface (HDMI) terminals, etc. The plurality of receivers 110-1, 110-2, . . . , and 110-n may include various other types of receivers according to other exemplary embodiments. The plurality of receivers 110-1, 110-2, . . . , and 110-n are not limited to receive contents from the same type of source. Instead, the plurality of receivers may receive contents from different types of sources.

The plurality of signal processors 120-1, 120-2, . . . , and 120-n form image frames of a 2D content or a 3D content and perform various types of signal-processing with respect to the received contents. In an exemplary embodiment, in a multi-2D mode, the plurality of signal processors 120-1, 120-2, . . . , and 120-n alternately form image frames of a plurality of 2D contents. The plurality of signal processors 120-1, 120-2, . . . , and 120-n perform decoding or scaling. The plurality of signals 120-1, 120-2, . . . , and 120-n may adjust at least one of a brightness, a contrast, a resolution, a sharpness, a black tone, positions and sizes of subtitles, a master volume, equalizer information (a balance, an amplification level according to frequency bands), SRS TruSurround HD, a sharpness, and a black tone.

The plurality of signal processors 120-1, 120-2, . . . , and 120-n may include elements which separately provide audio data for each content in the multi-2D mode. In other words, the plurality of signal processors 120-1, 120-2, . . . , and 120-n may further include demultiplexers (not shown), audio decoders (not shown), modulators (not shown), output units (not shown), etc. The demultiplexers separate video data and audio data from the contents received by the receivers 110-1, 110-2, . . . , and 110-n. The audio decoders decode the audio data, and the modulators modulate the decoded audio data into signals having different frequencies. The output parts transmit the modulated audio data to an eyeglass apparatus. The audio data output from the output part 130 is provided to a user through an output means such as earphones installed in the eyeglass apparatus. These elements are not directly related to the exemplary embodiment, and additional illustrations thereof will be omitted.

If a content includes additional information such as an electronic program guide (EPG) and subtitles, the additional data may be separated from the content through the demultiplexers. The display apparatus 100 may add subtitles, etc. processed through an additional data processor (not shown) to a corresponding image frame to be displayed on the display apparatus 100.

The plurality of signal processors 120-1, 120-2, . . . , and 120-n may independently convert frame rates of a plurality of received contents.

In other words, the plurality of signal processors 120-1, 120-2, . . . , and 120-n may convert the frame rates of the contents according to a multi-content display rate with reference to an output rate of the display apparatus 100. In an exemplary embodiment, if the display apparatus 100 operates at a frequency of 60 Hz, the plurality of signal processors 120-1, 120-2, . . . , and 120-n may convert a frame rate of each content into nx60 Hz.

In an exemplary embodiment, an image frame rate of a content may be set to 120 Hz in the case of Full High Definition (FHD) in a single 2D mode. If image frames of two 2D contents are alternately output in a multi-2D mode, image frame rates of the 2D contents may be each set to 240 Hz.

The plurality of signal processors 120-1, 120-2, . . . , and 120-n may independently convert frame rates. In other words, frame frequencies of a plurality of contents may be different according to the different types of the plurality of contents, and the plurality of signal processors 120-1, 120-2, . . . , and 120-n may independently convert frame rates of the plurality of contents.

If the above-described operation is performed by one signal processor, and frame frequencies are different from one another before frame rates of a plurality of contents are converted, image frames of a plurality of contents at a particular time are formatted as one image frame so that the frame frequencies are equal to one another. In an exemplary embodiment, at least one additional image frame may be inserted between image frames of a content having a relatively low frame rate to equally adjust frame rates of a plurality of received contents. At least one of the image frames of a content having a relatively high frame rate may be deleted to equally adjust frame rates of a plurality of received contents. Image frames of a plurality of contents at a particular time are formatted as one image frame, and a frame rate of the formatted one image frame is converted to equally adjust frame rates of the plurality of contents at a particular time.

Even if frame rates of a plurality of contents are equal to one another, image frames of the plurality of contents may be formatted at a particular time as one image frame. However, in this case, a operation of adding or deleting an image frame as described above is unnecessary.

If a frame rate is converted after an image formatting operation is performed as described above, a time is required for the image formatting operation, and a deformatting operation for dividing a formatted image frame into a plurality of image frames is performed. As a result, an image processing speed is delayed. If two or more image frames are compressed into one image frame, a part of an image is deleted, and a resolution loss occurs. If original frame rates of contents are different from one another, an additional image frame may be inserted, and the frame rates may be converted at a time. Intervals of image frames of a content, into which a new image frame is inserted, are not uniform, and an unnatural image is displayed.

If frame rates of a plurality of contents are equal to one another, a formatting operation is not performed. Instead, a reference clock is increased to increase a transmission speed of an image frame. There is no resolution loss, but a load occurs in a system, and thus a large amount of power is consumed. However, if frame rates of a plurality of contents are different from one another, it is difficult to rapidly and differently change the frame rates according to the contents and to change the reference clock in order to change the frame rates of the plurality of contents.

In an exemplary embodiment, a plurality of signal processors are provided to independently convert frame rates of contents. As a result, an additional image frame formatting operation is unnecessary, and the processing speed may be increased. Also, there is no loss of resolution, the reference clock does not need to be adjusted, and power consumption may be reduced. In addition, the frame rate increases at a predetermined ratio based on an original frame rate of each content. Therefore, although original frame rates of a plurality of contents are different from one another, a correct image may be displayed.

The output part 130 is an element which alternately outputs image frames of a plurality of contents according to a frame rate converted based on the multi-2D mode. Although not shown in FIG. 2, image frames whose frame rates are converted by the plurality of signal processors 120-1, 120-2, . . . , and 120-n are multiplexed through a MUX (not shown), and the output part 130 sequentially arranges and outputs image frames of each content. The output part 130 sequentially outputs image frames of one 2D content in a single 2D mode and alternately outputs left and right eye image frames of one 3D content in a 3D mode. The output part 130 may include at least one of a liquid crystal display panel (LCDP), a plasma display panel (PDP), an organic light-emitting diodes (OLED), a vacuum fluorescent display (VFD), a field emission display (FED), and an electroluminescence display (ELD). A detailed hardware configuration of the output part 130 will be described later.

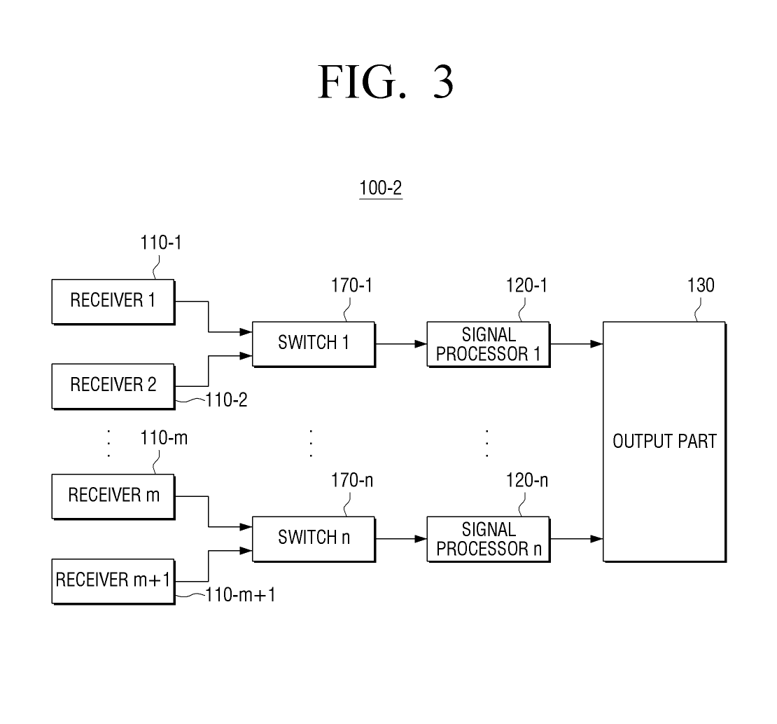

FIG. 3 is a block diagram illustrating a configuration of a display apparatus 100-1 further including a switching part according to another exemplary embodiment.

Referring to FIG. 3, the display apparatus 100-1 further includes a switch 170 in addition to the elements described with reference to FIG. 2. The switching part 170 connects at least two of a plurality of receivers to a signal processor 120. As shown in FIG. 3, first and second receivers 110-1 and 110-2 are connected to a first switch 170-1. The first switch 170-1 selects one of the first and second receivers 110-1 and 110-2 as a source and transmits the data from the selected source to a first signal processor 120-1. Similarly, m^{th} and m+1^{th} receivers 110-m and 100-m−1 are connected to an n^{th} switch 170-n. The n^{th} switch 170-n selects one of the m^{th} and m+1^{th} receivers 110-m and 100-m−1 as a source and transmits the data from the selected source to an n^{th} signal processor 120-n.

The display apparatus 100-1 according to the exemplary embodiment includes a plurality of receivers 110-1, 110-2, . . . , and 110-n and selects at least two contents for multi-view viewing to process a signal. In particular, the display apparatus 100-1 according to the exemplary embodiment includes the switch 170 to allow viewers to view different contents, to select desired contents, and to change the desired contents in real time.

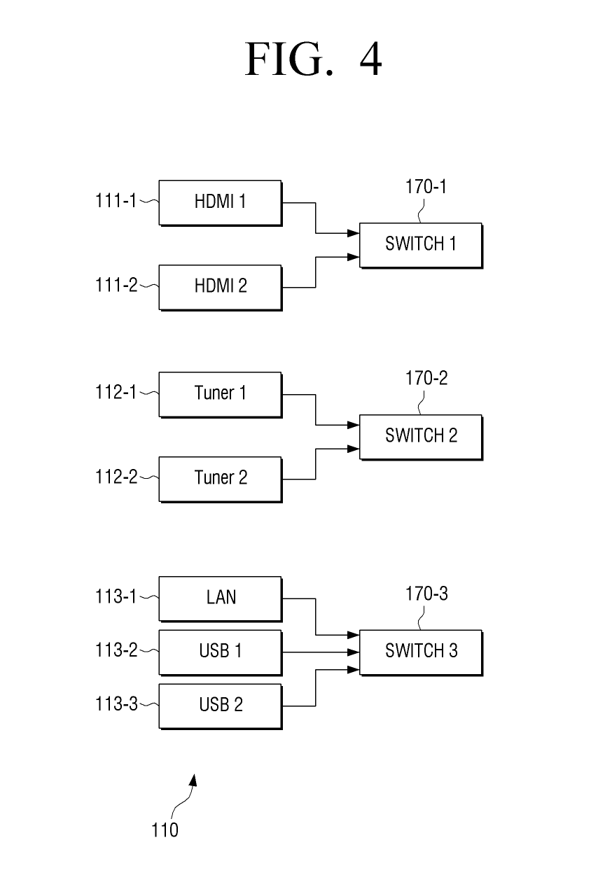

FIG. 4 is a block diagram illustrating a configuration of the switch 170 shown in FIG. 3 according to an exemplary embodiment.

Referring to FIG. 4, the switch 170 includes first, second, and third switches (integrated circuit (IC) switches) 170-1, 170-2, and 170-3. A receiver 110 includes a first HDMI port 111-1, a second HDMI port 111-2, a first tuner 112-1, a second tuner 112-1, a local area network (LAN) 113-1, a first USB 113-2, and a second USB 113-3.

The first switch 170-1 selects one of the first HDMI port 111-1 and the second HDMI port 111-2. HDMI is one of incompressible type digital video/audio interface standards. The HDMI standard provides an interface between apparatuses such as a set-top box supporting the HDMI standard, an AV apparatus of a multimedia source such as a DVD player or the like, a monitor, a digital television, etc.

The second switch 170-2 selects one of the first and second tuners 112-1 and 112-2. If a broadcast content is received from a broadcasting station by using a broadcast network as described above, the first and second tuners 112-1 and 112-2 respectively receive different broadcast contents, and the second switch 170-2 selects a broadcast content based on a user's selection.

The third switch 170-3 selects one of the LAN 113-1, the first USB 113-2, and the second USB 113-3.

The LAN 113-1 includes a wireless LAN module and accesses a wireless access point (AP) (not shown) existing within a preset range to be connected to the Internet. The LAN 113-1 receives a content from a web server which transmits a content file through the Internet. The LAN 113-1 supports wireless LAN standard IEEE802.11x of Institute of Electrical and Electronics Engineers (IEEE)

The first USB 113-2 and the second USB 113-3 include USB ports to receive contents from various types of recording media players connected to the display apparatus 100-1. If the first and second USBs 113-2 and 113-3 support USB 3.0, contents may be received at a transmission speed of 5 Gbps.

Each of the first, second, and third switches 170-1, 170-2, and 170-3 provides a function of selecting a content received from a source to provide the selected content to the signal processor 120. Therefore, each of the first, second, and third switches 170-1, 170-2, and 170-3 efficiently provides a content selected by a user viewing a multi-view.

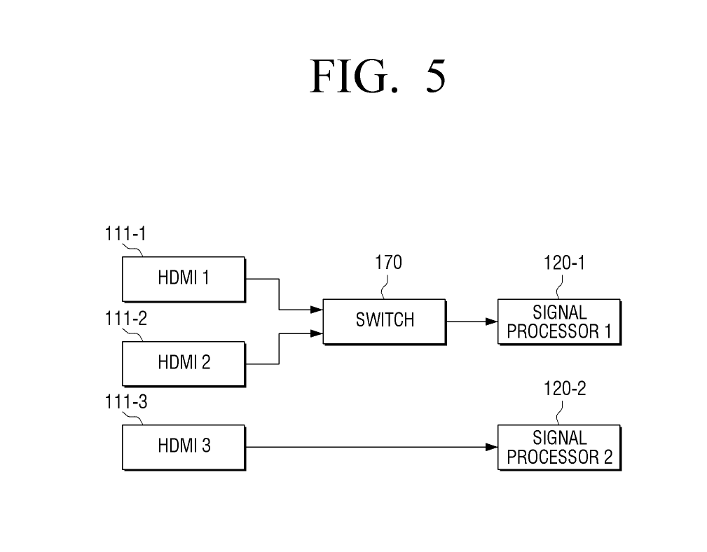

FIG. 5 is a block diagram illustrating a configuration of the switch 170 shown in FIG. 3 according to another exemplary embodiment.

Referring to FIG. 5, a switch 170 selects one of the content signals received from first and second HDMI ports 111-1 and 111-2 and provides the selected content signal to a first signal processor 120-1. A third HDMI port 111-3 is directly connected to a second signal processor 120-2 to transmit a received content signal to the second signal processor 120-2.

As described above, the receiver 110 may be connected to the signal processor 120 through various interfaces to improve efficiency of the signal-processing.

An operation of formatting an image through the display apparatus 100-1 according to an exemplary embodiment will now be described. The basic operation principle is similar to the operation principle of the signal processor 120 described above.

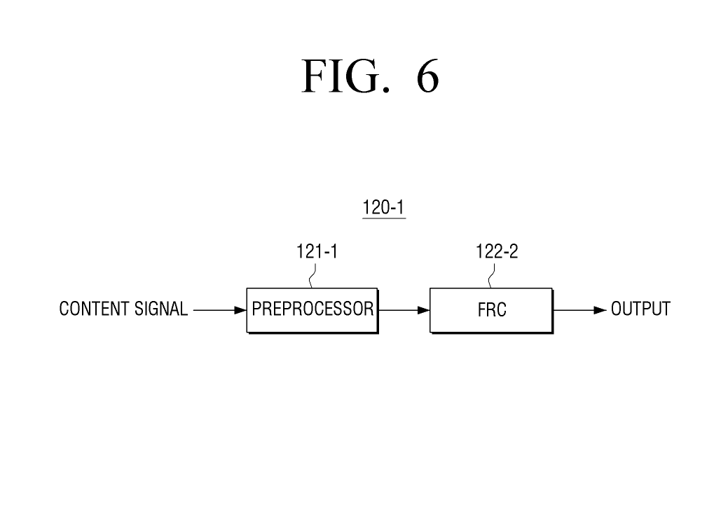

FIG. 6 is a block diagram illustrating a configuration of a signal processor 120-1 according to another exemplary embodiment.

Referring to FIG. 6, the signal processor 120-1 includes a preprocessor 121-1 and a frame rate converter (FRC) 122-2.

The preprocessor 121-1 performs image-formatting and transmits a formatted image frame to the FRC 122-2. In an exemplary embodiment, the preprocessor 121-1 compresses image frames of each of a plurality of contents into one image frame and provides the one image frame to the FRC 122-2.

The image formatting includes an operation of converting a plurality of image frames into one image frame. In an exemplary embodiment, two image frames of each content for a dual view at a particular time may be compressed into one image frame. The compression is performed to perform signal-processing at a time or to secure a data transmission amount within a preset time.

If frame rates of a plurality of contents are equal to one another, image frames of the plurality of contents at a particular time may be formatted into one image frame. However, an operation of adding or deleting an image frame is unnecessary.

If the frame rates of the plurality of contents are different from one another, an image frame may be added or deleted to equally adjust the frame rates of the plurality of contents before the frame rates of the plurality of contents are converted. If the frame rates of the plurality of contents are not different from one another, an image frame of a content of one side does not exist at a particular time, and thus image formatting is impossible.

The preprocessor 121-1 may insert at least one additional image frame between image frames of a content having a relatively low frame rate to equally adjust frame rates of a plurality of received contents. The preprocessor 121-1 may delete at least one image frame of a content having a relatively high frame rate to equally adjust frame rates of a plurality of received contents. After image frames of a plurality of contents at a particular time are formatted into one image frame, the FRC 122-2 converts a frame rate of the formatted image frames one at a time to equally adjust frame rates of the plurality of contents.

Although not shown in FIG. 6, after the FRC 122-2 converts the frame rate, an un-formatting operation to restore the formatted image frame to a plurality of image frames is required. The un-formatted image frames are alternately output according to a frame rate converted by the output part 130.

If image formatting is performed as described above, frame rates may be converted at a time through one FRC 122-2. However, a loss of a resolution may occur as described above. Also, if original frame rates of contents are different from one another, an additional image frame may be inserted, and the original frame rates may be converted at a time. Intervals of image frames of a content into which an image frame is newly inserted are not uniform, thereby displaying an unnatural image.

Alternatively, if frame rates of a plurality of contents are equal to one another, a reference clock may be increased to increase a transmission speed of an image frame without performing a formatting operation. According to an exemplary embodiment, although a plurality of FRCs 122-2 are not installed, a loss of a resolution may not occur.

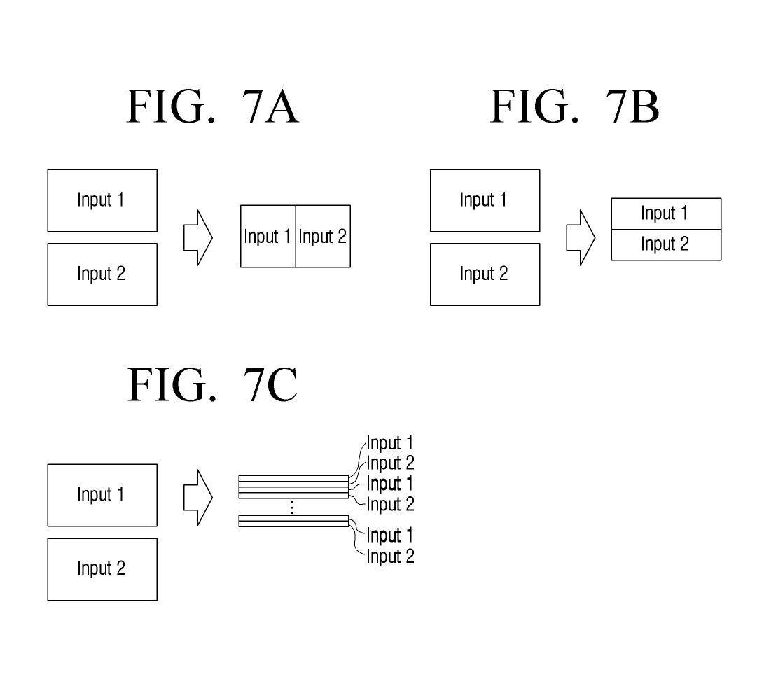

FIGS. 7A through 7C are views illustrating an image formatting method according to a configuration shown in FIG. 6.

Referring to FIG. 7A, the preprocessor 121-1 combines image frames of each content side by side in a horizontal direction to convert the image frames into a side-by-side format. Referring to FIG. 7B, the preprocessor 121-1 combines image frames of each content in top and down directions to convert the image frames into a top-down format. Referring to FIG. 7C, the preprocessor 121-1 alternately compresses image frames of a content in a line format, i.e., in units of lines. This method may guarantee a more efficient speed in interlace type image-processing

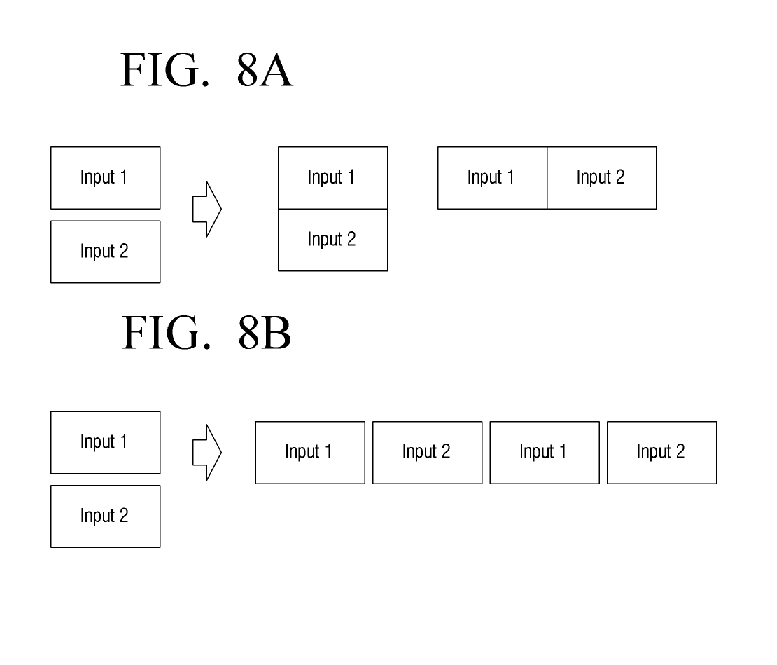

FIGS. 8A and 8B are views illustrating the preprocessor 121-1 according to another exemplary embodiment.

Referring to FIG. 8, the preprocessor 121-1 formats image frames of each of a plurality of received contents according to a frame packing method and provides the formatted image frames to the signal processor 120.

The frame packing method refers to a method of sequentially outputting image frames without compressing image frames of each content into one image frame at a particular time as shown in FIG. 8B. According to the frame packing method, a part of an image frame does not need to be discarded. As a result, there is no loss of a resolution, and it is possible to display a natural image. However, in general, a transmission time is required that is higher than the transmission time for transmitting one image frame.

The display apparatus 100-1 including the plurality of signal processors 121-1, . . . , and 121-n described above processes image frames in parallel. As a result, the display apparatus 100-1 enables fast processing of the image frames. Although image frames are transmitted according to the frame packing method, an additional processor processes the image frames. Therefore, the processing speed is increased, and a natural image is displayed in an original resolution.

If image frames are processed through one signal processor, a reference clock is increased as described above.

If a plurality of signal processors are installed, the plurality of signal processors independently convert frame rates of contents. As a result, an additional image frame formatting operation is unnecessary, and a processing speed is increased. Also, a loss of a resolution does not occur, and a reference clock does not need to be adjusted and power consumption is reduced. In addition, a frame rate increases at a predetermined ratio based on an original frame rate of each content. Although original frame rates of a plurality of contents are different from one another, a natural image is displayed.

A configuration and an operation of a display apparatus 100-3 including the above-described elements will now be described according to another exemplary embodiment.

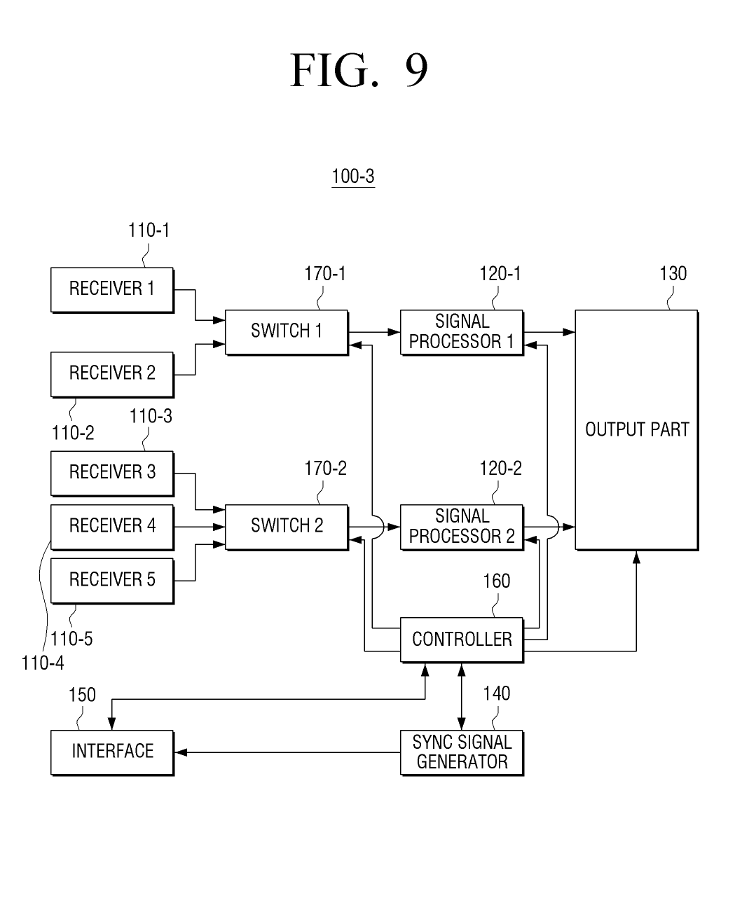

FIG. 9 is a block diagram illustrating the configuration of the display apparatus 100-3 according to another exemplary embodiment.

Referring to FIG. 9, the display apparatus 100-3 includes a plurality of receivers 110-1, 110-2, 110-3, 110-4, and 110-5, a plurality of switches 170-1 and 170-2, a plurality of signal processors 120-1 and 120-2, a sync signal generator 140, an interface 150, a controller 160, and an output part 130.

The plurality of receivers 110-1, 110-2, 110-3, 110-4, and 110-5, the plurality of switches 170-1 and 170-2, and the plurality of signal processors 120-1 and 120-2 are described in the previous exemplary embodiments, and their repeated descriptions will be omitted.

The sync signal generator 140 generates a sync signal to synchronize an eyeglass apparatus corresponding to each content according to a display timing of each content. Since an eyeglass apparatus 200 does not need to be synchronized in a single 2D mode, an additional sync signal is not required. In a multi-2D mode, the sync signal generator 140 generates sync signals corresponding to the number of contents and transmits the sync signals to the eyeglass apparatus 200. Since opening and closing timings of left and right shutter glasses of the eyeglass apparatus 200 are equal to each other, the eyeglass apparatus 200 receives only one sync signal from the display apparatus 100.

In a 3D mode, the sync signal generator 140 generates two types of sync signals corresponding to left and right eye image frames. The eyeglass apparatus 200 receives the two types of sync signals and opens and/or closes the left and right shutter glasses according to the two types of sync signals. As described above, the eyeglass apparatus may receive one sync signal to be synchronized with a section of the sync signal.

A sync signal may be generated according to a Bluetooth communication standard for shutter glass type 3D eyeglasses. The display apparatus 100-3 includes the generated sync signal in a Bluetooth transmission stream according to the Bluetooth communication standard and transmits the sync signal included in the Bluetooth transmission stream to the eyeglass apparatus 200.

The interface 150 receives a user command. The user command includes various types of commands for controlling the display apparatus 100-3. The user command may be generated and transmitted from a remote control apparatus (hereinafter referred to as a remote controller) or from the eyeglass apparatus 200. In particular, the interface 150 performs paring with the eyeglass apparatus 200 and transmits a transmission stream including a sync signal to the eyeglass apparatus 200 to synchronize with the eyeglass apparatus 200.

In an exemplary embodiment, the interface 150 may be implemented as a Bluetooth communication module. The interface 150 may generate a transmission stream according to the Bluetooth communication standard so that the transmission stream includes the sync signal and may transmit the transmission stream including the sync signal to the eyeglass apparatus 200.

The Bluetooth communication technology refers to a near field communication (NFC) method of transmitting a data stream in a data packet form by using 79 channels between 2402 MHz and 2480 MHz except in a range between 2 MHz after the Industrial Scientific and Medical (ISM) band 2400 MHz and 3.5 MHz before 2483.5 MHz.

If the Bluetooth communication technology is used, the display apparatus 100-3 receives an inquiry message from the eyeglass apparatus 200 and listens to the inquire message. The display apparatus 100-3 transmits an Extended Inquire Response (EIR) packet including a path loss threshold value. If the display apparatus 100-3 receives an association notification packet for requesting an association notification based on a path loss value from the eyeglass apparatus 200, the display apparatus 100-3 transmits a baseband ACK to the eyeglass apparatus 200 in response to the association notification packet.

The EIR packet includes information about a test mode for Bluetooth qualification body test, a path loss threshold, etc.

The display apparatus 100-3 transmits transmission timing information of a beacon packet including a control signal of the eyeglass apparatus 200 to the eyeglass apparatus 200. If the display apparatus 100-3 transmits a reconnect train packet including the transmission timing information of the beacon packet to the eyeglass apparatus 200, and the eyeglass apparatus 200 does not find the reconnect train packet within a preset time, the display apparatus 100-3 receives a page packet from the eyeglass apparatus 200. The reconnect train packet is formed without frequency hopping.

The beacon packet includes a Bluetooth (BT) clock at a rising edge of a frame sync, a left shutter open offset or video stream 1 in a dual-view mode, a left shutter close offset or the video stream 1 in the dual-view mode, a right shutter open offset or video stream 2 in the dual-view mode, a right shutter close offset or the video stream 2 in the dual-view mode, a frame sync period (integer)/frame sync period (fraction), etc.

The display apparatus 100-3 transmits the beacon packet to the eyeglass apparatus 200 according to the transmission timing information.

Through a paring process and a sync signal transmitting process as described above, the interface 150 may match information about different eyeglass apparatuses with each content according to an arrangement order of image frames of contents. In other words, if two contents are alternately provided in a multi-view mode (a multi-2D mode), first, third, . . . , and n^{th} (n being an odd number) arranged image frames of a content may match with information about a first eyeglass apparatus, and second, fourth, . . . , and n+1^{th} arranged image frames of the content may match with information about a second eyeglass apparatus. If the eyeglass apparatus 200 receives a sync signal, the eyeglass apparatus 200 checks a display timing corresponding to eyeglass apparatus information and opens or closes shutter glasses according to the determined display timing.

In the above-described exemplary embodiment, the interface 150 and the eyeglass apparatus 200 communicate with each other, but are not limited to a communication according to the Bluetooth communication method. Instead, the interface 150 and the eyeglass apparatus 200 may form a communication channel to communicate with each other by other short distance communication technologies, i.e., by various types of short distance communication methods including an infrared (IR) communication, Zigbee, a near field communication (NFC), etc.

In an exemplary embodiment, the interface 150 may provide an IR sync signal having different frequencies to the eyeglass apparatus 200. The eyeglass apparatus 200 receives a sync signal having a particular frequency to open or close the shutter glasses according to a display timing of a corresponding content.

The interface 150 may transmit an IR signal to the eyeglass apparatus 200, and a high level of a first period and a low level of a second period are alternately repeated at preset time intervals in the IR signal based on the sync information. The eyeglass apparatus 200 opens the shutter glasses for the first period for which the high level is maintained and closes the shutter glasses for the second period for which the low level is maintained. The sync signal may be generated according to various methods.

The controller 160 controls an overall operation of the display apparatus 100-3. In detail, the controller 160 controls the first and second signal processors 120-1 and 120-2, a Multiplexer (MUX) (not shown), the output part 130, the interface 150, the sync signal generator 140, and the first and second switches 170-1 and 170-2 to allow the first and second signal processors 120-1 and 120-2, the MUX (not shown), the output part 130, the interface 150, the sync signal generator 140, and the first and second switches 170-1 and 170-2 to perform their corresponding operations. The controller 160 controls the first and second signal processors 120-1 and 120-2 to receive a plurality of contents constituting a multi-view and to independently convert frame rates of the plurality of contents. The controller 160 controls the output part 130 to alternately output the plurality of contents according to the converted frame rates.

The controller 160 may be implemented by hardware as a microprocessor, an IC chip, a central processing unit (CPU), or a microprocessor unit (MPU) and may be controlled by an operating system (OS) and a software application. A control command for an operation of the display apparatus 100-3 is read from a memory according to a system clock, and an electric signal is generated according to the read control command to operate the elements of the hardware.

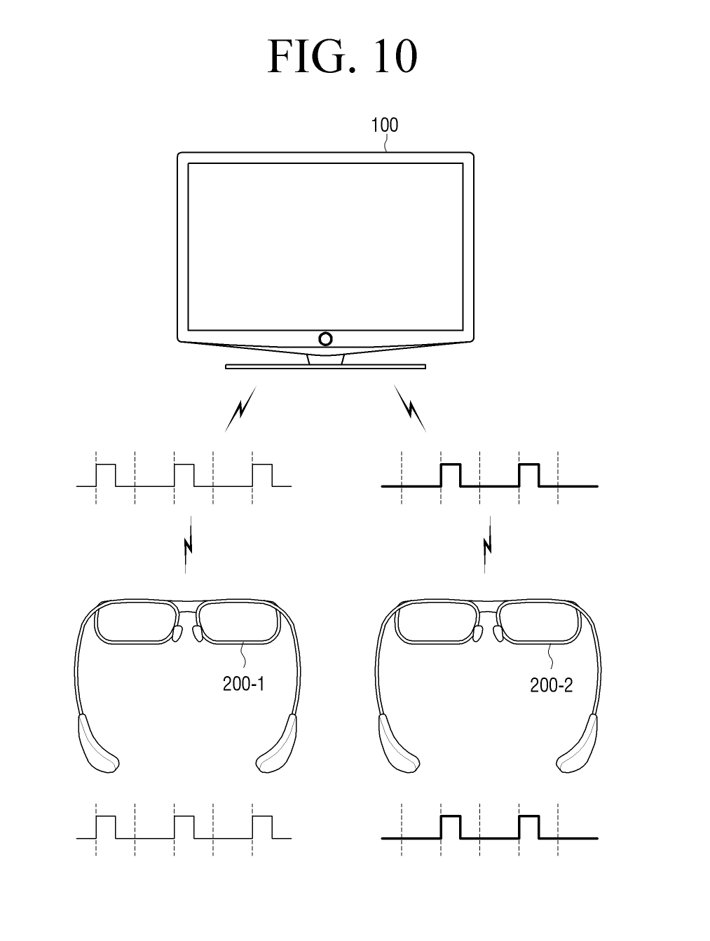

FIG. 10 is a view illustrating a communication casting method of transmitting a sync signal according to an exemplary embodiment.

According to this exemplary embodiment, a display apparatus 100 broadcasts or multicasts one signal obtained by multiplying sync signals corresponding to a plurality of different eyeglass apparatuses. Each of the eyeglass apparatuses synchronizes with one of the sync signals corresponding to a user command (e.g., a channel change command) to open and/or close shutter glasses. A multi-casting method is used in the Bluetooth communication standard for the shutter glass type 3D eyeglass described above.

Referring to FIG. 10, the display apparatus 100 unicasts sync signals corresponding to the first and second eyeglass apparatuses 200-1 and 200-2 to the first and second eyeglass apparatuses 200-1 and 200-2. The first and second eyeglass apparatuses 200-1 and 200-2 may receive the corresponding sync signals.

The output part 130 will now be described in more detail.

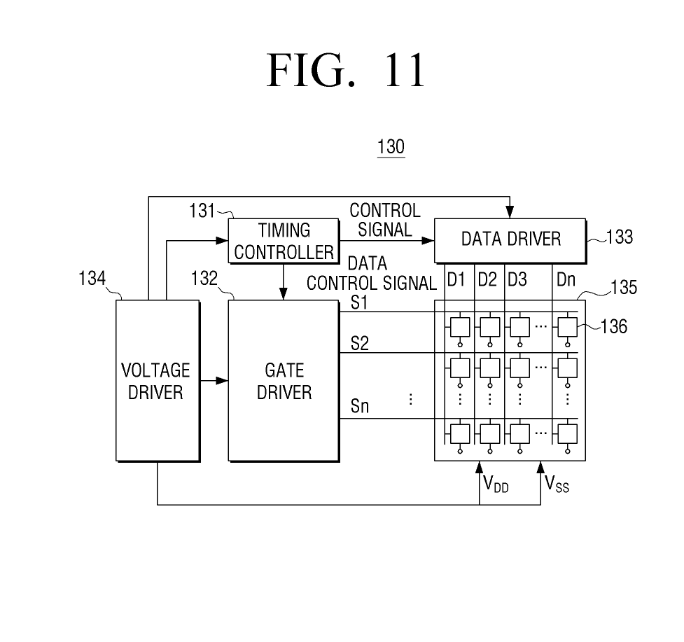

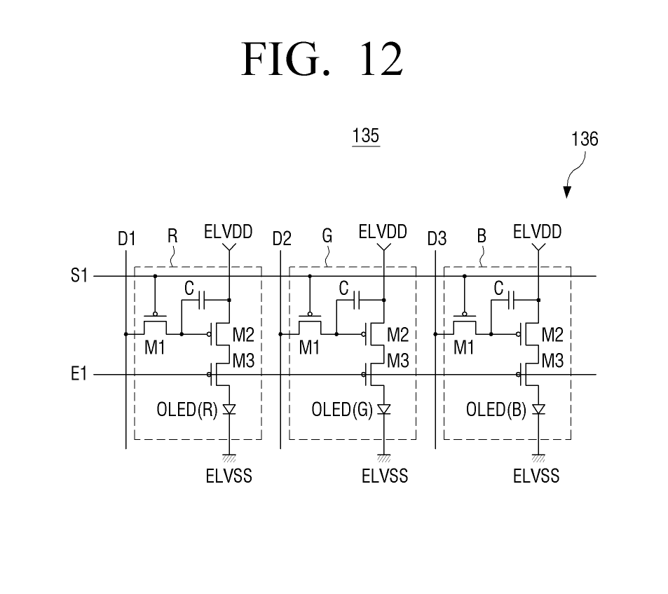

FIG. 11 is a block diagram illustrating a circuit configuration of the output part 130. FIG. 12 is a block diagram illustrating a circuit configuration of a display panel 135.

The output part 130 outputs a scaled 3D image frame. The output part 130 includes a timing controller 131, a gate driver 132, a data driver 133, a voltage driver 134, and a display panel 135.

The timing controller 131 receives a clock signal DCLK, a horizontal sync signal Hsync, a vertical sync signal Vsync, etc. appropriate for a resolution of the display apparatus 100 from an external source (not shown) to generate a gate or scan control signal (control signal) and a data control signal (data control signal), re-arranges received R, G, and B data, and provides the re-arranged R, G, B data to the data driver 133.

The timing controller 131 also generates a gate shift clock (GSC), a gate output enable (GOE), a gate start pulse (GSP), etc., in relation to the gate control signal. The GSC is a signal to determine a time when thin film transistors (TFTs) connected to light-emitting devices, such as R, G, and B organic light-emitting diodes (OLEDs), are turned on and/or off. The GSP is a signal to control an output of the gate driver 132, and the GSP is a signal to notify a first driving line of one vertical sync signal on a screen.

The timing controller 131 further generates a source sampling clock (SSC), a source output enable (SOE), a source start pulse (SSP), etc. in relation to the data control signal. The SSC is used as a sampling clock for latching data in the data driver 133 and to determine a driving frequency of a data drive IC. The SOE is a signal to transmit data latched by the SSC to the display panel 135. The SSP is a signal to notify a start of latching and sampling of data for a first horizontal sync period.

The gate driver 132 generates the scan signal and is connected to the display panel 135 through scan lines S1, S2, S3, . . . , and Sn. The gate driver 132 applies a gate on/off voltage Vgh/Vgl provided from the voltage driver 134 to the display panel 135 according to the gate control signal generated by the timing controller 131. The gate on voltage Vgh is provided sequentially from a first gate line GL1 to an N^{th} gate line GLn to generate a frame image on the display panel 135.

The data driver 133 generates the data signal and is connected to the display panel 135 through data lines D1, D2, D3, . . . , and Dm. The data driver 133 inputs RGB data of 3D left and right eye image frames of completely scaled 3D image data into the display panel 135 according to the data control signal generated by the timing controller 111. The data driver 133 converts serial RGB data provided by the timing controller 131 into parallel RGB data and converts digital data into analog data to provide image data corresponding to one horizontal line to the display panel 135. This operation is performed sequentially with respect to horizontal lines.

The voltage driver 134 generates driving voltages and respectively transmits the driving voltages to the display panel 135, the gate driver 132, and the data driver 133. In other words, the voltage driver 134 receives commercial power, i.e., an alternating current (AC) of 110V or 220V, from an external source (not shown) to generate and provide a power supply voltage VDD necessary for the display panel 135 or provide a ground voltage VSS. The voltage driver 134 generates the gate on voltage Vgh and provides the gate one voltage Vgh to the gate driver 132. The voltage driver 134 may include a plurality of voltage driving modules (not shown) which operate individually. The plurality of voltage driving modules may be controlled by the controller 160 to provide different voltages. The controller 160 may control the voltage driver 134 to provide different driving voltages through the plurality of voltage driving modules according to preset information. In an exemplary embodiment, the plurality of voltage driving modules may provide different first voltages and second voltages set to default according to the preset information under control of the controller 160.

According to an exemplary embodiment, the voltage driver 134 may include a plurality of voltage driving modules respectively corresponding to a plurality of areas of the display panel 135. The controller 160 may control the plurality of voltage driving modules to provide different first voltages, i.e., voltages ELVDD, according to screen information (or input image information) of the plurality of areas. In other words, the controller 160 may control intensities of the voltages ELVDD by using an image signal input into the data driver 133. The screen information may be at least one of luminance and gradation information of an input image.

The display panel 135 includes pixel areas 136 in which a plurality of gate lines GL1 through GLn intersect with a plurality of data lines DL1 through DLn to define the pixel areas 136. R, G, and B light-emitting devices such as OLEDs are formed in the pixel areas 136. Switching elements, i.e., TFTs, are formed in areas of the pixel areas 136, in particular at corners of the pixel areas 136. When the TFTs are turned on, gradation voltages are provided to the R, G, and B light-emitting devices from the data driver 133. The R, G, and B light-emitting devices provide light in response to an amount of current provided based on the gradation voltages. In other words, if a large amount of current is provided, the R, G, and B light-emitting devices provide a large amount of light.

The R, G, and B pixel areas 136 will now be described in more detail with reference to FIG. 12. The display panel 135 includes switching elements M1, switching elements M2, and switching elements M3. The switching elements M1 operate through a scan signal 51, i.e., the gate on voltage Vgh. The switching elements M2 output currents based on pixel values including changed high gradation values provided to the data lines D1 through Dn. The switching elements M3 adjust amounts of the currents provided from the switching elements M2 to the R, G, and B light-emitting devices according to the control signal provided from the timing controller 131. The switching elements M3 are connected to the OLEDs to supply currents to the OLEDs. The OLEDs refer to displays which self-emit light by suing a principle of emitting an electric field through a current flowing in fluorescent or phosphoric organic thin films. Anode electrodes of the OLEDs are connected to pixel circuits, and cathode electrodes of the OLEDs are connected to second power sources ELVSS. The OLEDs generate lights having predetermined luminances in response to the current supplied from the pixel circuits. The gate electrodes of the switching elements M1 are connected to a scan line 51, and first electrodes of the switching elements M1 are connected to a data line D1.

As described above, the display panel 135 may be implemented by, but is not limited to an active matrix organic light-emitting diode (AM-OLED) panel. Instead, the display panel 135 may also be implemented by a passive matrix OLED (PM-OLED) which simultaneously emits light to be driven.

The OLEDs are described in the exemplary embodiment shown in FIG. 12. However, the output part 130 is not limited to the exemplary embodiment shown in FIG. 12 and may be implemented by various types of display technologies such as an LCDP, a PDP, an OLED, a VFD, a FED, an ELD, etc.

An eyeglass apparatus 200 according to an exemplary embodiment of the present general inventive concept will now be described.

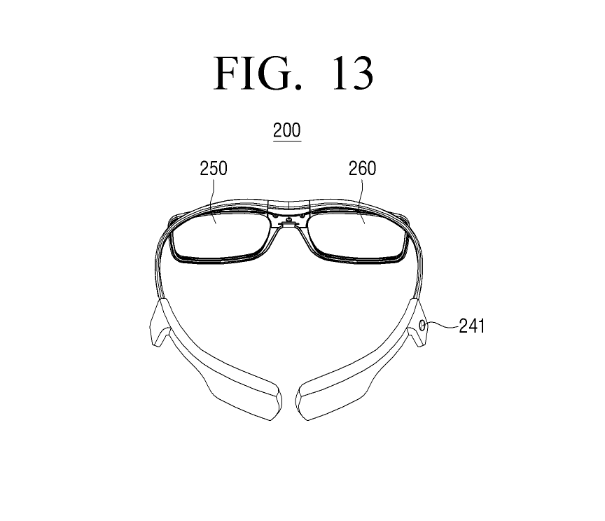

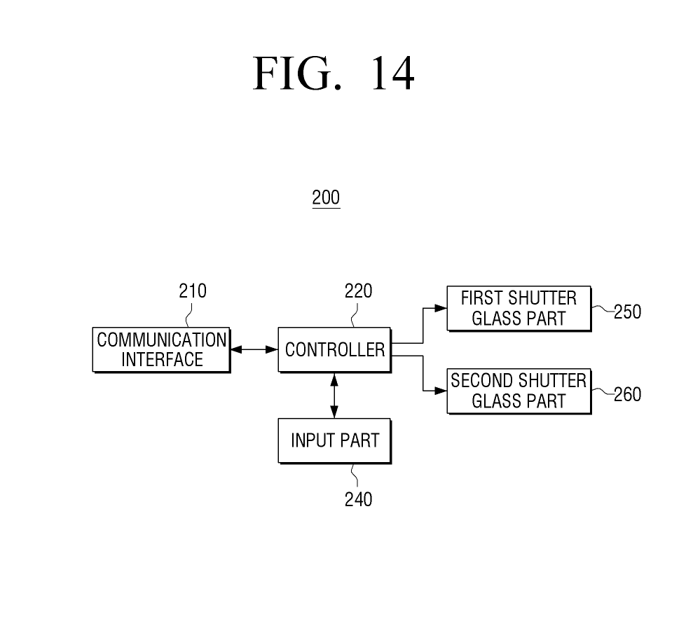

FIG. 13 is a perspective view illustrating an external appearance of the eyeglass apparatus 200 according to an exemplary embodiment. FIG. 14 is a block diagram illustrating a configuration of the eyeglass apparatus 200 shown in FIG. 14.

Referring to FIGS. 13 and 14, the eyeglass apparatus 200 operates together with the display apparatus 100 as described above and includes a communication interface 210, a controller 220, a first shutter glass part 250, a second shutter glass part 260, and an input part 240.

The communication interface 210 communicates with the display apparatus 100 and receives a sync signal.

If the communication interface 210 receives a sync signal generated according to a Bluetooth communication standard for shutter glass type 3D eyeglasses from the display apparatus 100, the eyeglass apparatus 200 searches for a display apparatus to synchronize with the eyeglass apparatus 200. The eyeglass apparatus 200 synchronizes with the display apparatus 100 based on the search result.

An operation of checking the display apparatus 100 follows. The eyeglass apparatus 200 transmits an inquire message to the display apparatus 100 and receives from the display apparatus 100 an EIR packet including a path loss threshold value corresponding to the inquire message. The eyeglass apparatus 200 transmits an association notification packet to request an association with the display apparatus 100 to the display apparatus 100 according to a path loss value. Only if the path loss value is lower than the path loss threshold value, the eyeglass apparatus 200 transmits the association notification packet. The eyeglass apparatus 200 receives a baseband ACK packet corresponding to the association notification packet from the display apparatus 100.

If the eyeglass apparatus 200 is synchronized with the display apparatus 100, the eyeglass apparatus 200 receives transmission timing information of a beacon packet including a control signal of the eyeglass apparatus 200 from the display apparatus 100. The eyeglass apparatus 200 also receives the beacon packet from the display apparatus 100 according to the transmission timing information.

As described above, the beacon packet includes a BT clock at a rising edge of a frame sync, a left shutter open offset or video stream 1 in a dual-view mode, a left shutter close offset or the video stream 1 in the dual-view mode, a right shutter open offset or video stream 2 in the dual-view mode, a right shutter close offset or the video stream 2 in the dual-view mode, a frame sync period (integer)/frame sync period (fraction), etc.

The eyeglass apparatus 200 opens or closes shutter glasses according to a display timing of an image frame of a content corresponding to the eyeglass apparatus 200 with reference to the received beacon packet.

According to another exemplary embodiment, the communication interface 210 may be implemented as a IR receiving module to receive an IR sync signal having a particular frequency. The IR sync signal includes time information for opening or closing the first and second shutter glass parts 250 and 260 of the eyeglass apparatus 200 to synchronize the eyeglass apparatus 200 with a display timing of an image frame of a content.

The controller 220 controls an overall operation of the eyeglass apparatus 200. The controller 220 transmits the sync signal received by the communication interface 210 to a shutter glass driver (not shown) and controls an operation of the shutter glass driver. In other words, the controller 220 controls the shutter glass driver to generate a driving signal for driving the first and second shutter glass parts 250 and 260 based on the sync signal.

The shutter glass driver generates the driving signal based on the sync signal received from the controller 220. In particular, the shutter glass driver may open the first and second shutter glass parts 250 and 260 according to a display timing of an image frame of a 2D or 3D content displayed in the display apparatus 100, based on the sync signal

The first and second shutter glass parts 250 and 260 open or close shutter glasses according to the driving signal received from the shutter glass driver. In the case of a 2D multi-view content, the first and second shutter glass parts 250 and 260 are simultaneously opened or closed.

In the case of a 3D content, the first and second shutter glass part 250 and 260 are alternately opened and closed. In other words, according to the driving signal, the first shutter glass part 250 is opened according to a display timing of a left eye image frame of a 3D content, and the second shutter glass part 260 is opened according to a display timing of a right eye image frame of the 3D content.

The first and second shutter glass parts 250 and 260 may include liquid crystal cells. Orientations of the liquid crystal cells are switched according to the driving voltage, and the liquid crystal cells block or transmit light according to the switched orientations. In a 3D mode, the shutter glass driver of the eyeglass apparatus 200 applies a voltage to the first shutter glass part 250 at a display timing of a left eye image frame of a 3D mode, and the liquid crystal cells are oriented by the applied voltage to transmit light. The shutter glass driver of the eyeglass apparatus 200 does not apply the voltage to the second shutter glass part 260 at the same display timing, and the liquid crystal cells are scattered to diffuse or shield light. If a right eye image frame of a 3D content is displayed, an opposite operation occurs.

The first and second shutter glass parts 250 and 260 may further include polarizing films or retarder films. The polarizing films transmit light polarized in a particular direction, and the retarder films change a characteristic of polarized light to convert circularly polarized light into linearly polarized light or to convert linearly polarized light into circularly polarized light. If the display apparatus 100 includes this configuration, the display apparatus 100 polarizes and outputs an image and changes a characteristic of polarized light according to the orientation directions of the liquid crystal cells which operate as the retarder films to transmit only a desired image.

The input part 240 receives a user command and transmits a mode change command or a viewing environment setting command. As shown in FIG. 13, the input part 240 includes, but is not limited to a push button 241. Instead, the input part 240 may be implemented as a switch or a touch screen.

A display method according to an exemplary embodiment will now be described.

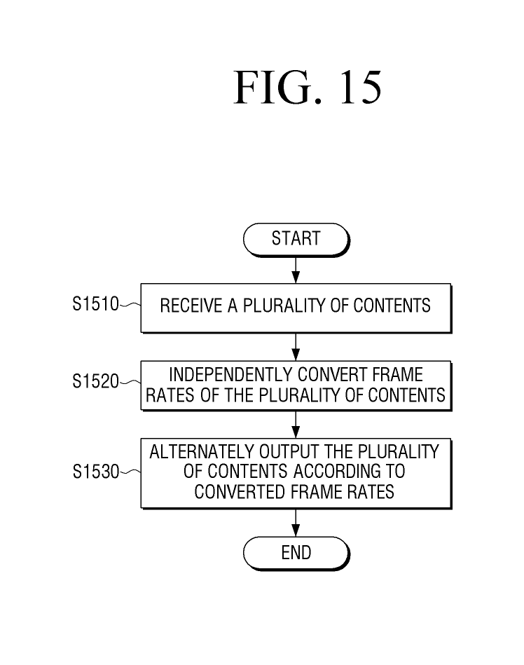

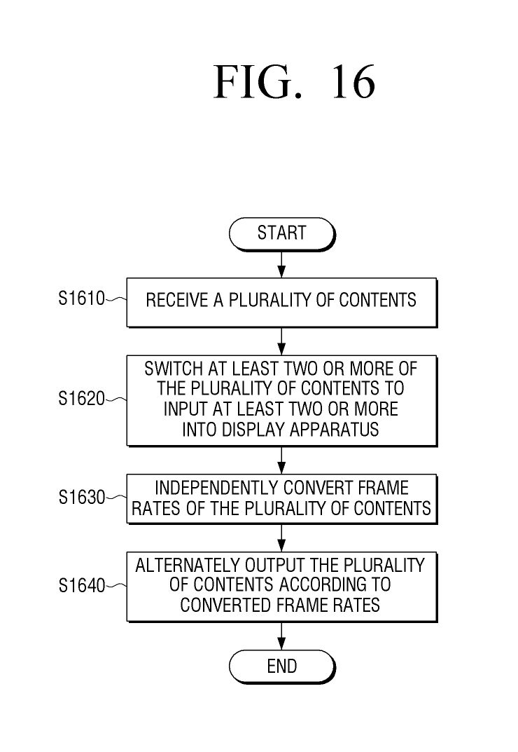

FIGS. 15 and 16 are flowcharts illustrating display methods according to exemplary embodiments.

Referring to FIG. 15, the display method according to an exemplary embodiment includes: receiving a plurality of contents constituting a multi-view (S1510); independently converting frame rates of the plurality of content (S1520); and alternately outputting the plurality of contents according to the converted frame rates (S1530). Operations S1510, S1520, and S1530 are described above, and their detailed descriptions will be omitted.

Referring to FIG. 16, the display method according to another exemplary embodiment includes: receiving a plurality of contents constituting a multi-view (S1610); switching at least two or more of the plurality of contents to input the at least two or more into a display apparatus (S1620); independently converting frame rates of the plurality of contents (S1630); and alternately outputting the plurality of contents according to the converted frame rates (S1640). Operations S1610, S1630, and S1640 correspond to operations S1510, 1520, and 1530 described above.

In the receiving operation, at least one of the plurality of contents may be received by using an HDMI port.

The above-described display methods may further include a preprocessing operation (not shown) of compressing image frames of each of the plurality of contents into one image frame and of providing the one image frame to the plurality of signal processors.

If the frame rates of the plurality of contents are different from one another, the preprocessing operation inserts at least one image frame between image frames of a content having a relatively low frame rate to equally adjust the frame rates of the plurality of contents.

If the frame rates of the plurality of contents are different from one another, the preprocessing operation deletes at least one of image frames of a content having a relatively high frame rate to equally adjust the frame rates of the plurality of contents.

The above-described display methods may further include a preprocessing operation (not shown) of formatting image frames of each of the plurality of contents according to a frame packing method.

The operation of independently converting the frame rates may include converting the frame rates of the plurality of contents to be equal to one another.

A program for performing methods according to the above-described various exemplary embodiments may be stored and used on various types of recording media.

Codes for performing the above-described methods may be stored on various types of non-transitory computer readable recording media such as a random access memory (RAM), a flash memory, a read only memory (ROM), en erasable programmable ROM (EPROM), an electrically erasable and programmable ROM (EEPROM), a register, a hard disk, a removable disk, a memory card, a USB memory, a CD-ROM, etc.

According to the above-described various exemplary embodiments, a display apparatus may include a frame rate converter (FRC) to independently convert frame rates of a plurality of contents in order to provide a natural multi-view display without a loss of a resolution.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a plurality of receivers which are configured to receive a plurality of contents of a multi-view content;
a plurality of signal processors which are configured to independently convert frame rates of the plurality of received contents; and
an output part which is configured to alternately output the plurality of contents according to the converted frame rates.

2. The display apparatus of claim 1, further comprising:
a switching part which is configured to connect at least two of the plurality of receivers to the plurality of signal processors.

3. The display apparatus of claim 1, wherein at least one of the plurality of receivers comprises a High Definition Multimedia Interface (HDMI) port.

4. The display apparatus of claim 1, further comprising:
a preprocessor which is configured to compress image frames of each of the plurality of contents into one image frame and to provide the one image frame to the plurality of signal processors.

5. The display apparatus of claim 4, wherein if the frame rates of the plurality of contents are different from one another, the preprocessor inserts at least one image frame between image frames of a content having a frame rate that is lower than a frame rate of another content to equally adjust the frame rates of the plurality of contents.

6. The display apparatus of claim 4, wherein if the frame rates of the plurality of contents are different from one another, the preprocessor deletes at least one of image frames of a content comprising a frame rate that is higher than a frame rate of another content to equally adjust the frame rates of the plurality of contents.

7. The display apparatus of claim 1, further comprising:
a preprocessor which is configured to format image frames of each of the plurality of contents according to a frame packing method and to provide the formatted image frames to the plurality of signal processors.

8. The display apparatus of claim 1, wherein the plurality of signal processors convert the frame rates of the plurality of received contents so that the frame rates are equal to one another.

9. A display method comprising:
independently receiving a plurality of contents of a multi-view content;
independently converting frame rates of the plurality of contents; and
alternately outputting the plurality of contents according to the converted frame rates.

10. The display method of claim 9, further comprising:
switching at least two of the plurality of received contents to input the at least two of the plurality of received contents to a display apparatus.

11. The display method of claim 9, wherein at least one of the plurality of contents is received by a High Definition Multimedia Interface (HDMI) port.

12. The display method of claim 9, further comprising:
compressing image frames of each of the plurality of received contents into one image frame and providing the one image frame to a plurality of signal processors.

13. The display method of claim 12, wherein if the frame rates of the plurality of received contents are different from one another, inserting at least one image frame between image frames of a content having a frame rate that is lower than a frame rate of another content to equally adjust the frame rates of the plurality of contents.

14. The display method of claim 12, wherein if the frame rates of the plurality of contents are different from one another, deleting at least one image frame of a content having a frame rate that is higher than a frame rate of another content to equally adjust the frame rates of the plurality of contents.

15. The display method of claim 9, further comprising:
formatting image frames of each of the plurality of received contents according to a frame packing method.

16. The display method of claim 9, wherein the frame rates of the plurality of contents are independently converted so that the frame rates of the plurality of received contents are equal to one another.

17. A non-transitory computer-readable recording medium recording a program which is executed by a computer to perform the display method of claim 9.

18. A content providing system comprising:
a first eyeglass apparatus;
a second eyeglass apparatus; and
a display apparatus comprising a plurality of receivers which are configured to receive a plurality of contents of a multi-view content, a plurality of signal processors which are configured to independently convert frame rates of the plurality of received contents, and an output part which is configured to alternately output the plurality of contents according to the converted frame rates, wherein the a first content displayed on the first eyeglass apparatus is different from a second content displayed on the second eyeglass apparatus.

19. The content providing system of claim 18, wherein the display apparatus comprises a switching part which is configured to connect at least two of the plurality of receivers to the plurality of signal processors, and
wherein the plurality of signal processors convert the frame rates of the plurality of received contents so that the frame rates are equal to one another.

20. The content providing system of claim 18, wherein the first eyeglass apparatus synchronizes with a first sync signal and the second eyeglass apparatus synchronizes with a second sync signal,
wherein the first sync signal and the second sync signal respectively correspond to a first user command and a second user command.

21. The content providing system of claim 20, wherein the first user command and the second user command comprise channel change commands.
